(19) United States
(12) Patent Application Publication
(10) Pub. No.: US 2025/0340389 A1
(43) Pub. Date: Nov. 6, 2025

(54) AUTOMATED CARGO UNLOADING MACHINE

(71) Applicant: STC ENG CO.,LTD., Pyeongtaek-si Gyeonggi-do (KR)

(72) Inventors: Byung Jin JUNG, Hwaseong-si Gyeonggi-do (KR); Jong Sam PARK, Hwaseong-si Gyeonggi-do (KR); Byung Taek JUNG, Osan-si Gyeonggi-do (KR)

(21) Appl. No.: 19/265,933

(22) Filed: Jul. 10, 2025

Related U.S. Application Data
(63) Continuation of application No. PCT/KR2023/006954, filed on May 22, 2023.

(51) Int. Cl. B65G 65/02; B25J 9/00; B65G 37/00

(52) U.S. Cl. CPC B65G 65/02; B25J 9/0093; B65G 37/00; B65G 2814/0311

(57) ABSTRACT

An automated cargo unloading machine is disclosed herein. The automated cargo unloading machine according to an embodiment of the present invention is an automated cargo unloading machine for unloading cargo loaded inside a cargo box including a main body frame, robotic arm devices provided at both sides of the main body frame, respectively, to unload the loaded cargo, and a conveyor device which is mounted on the main body frame, which is provided between the robotic arm devices, on which the cargo unloaded by the robotic arm devices is seated, and which transports the seated cargo to rearward.

### STATEMENT REGARDING GOVERNMENT SPONSORED RESEARCH OR DEVELOPMENT

The present invention was derived from a research conducted as a part of the Ministry of Trade, Industry and Energy's Robot Industry Core Technology Development Project-Cross-Departmental Cooperation Robot Product Technology (Project Identification No.: 1415168943, Sub-Project No.: 20009109, Research Project Title: Development of a Robot-Utilized Trunk line Cargo Logistics Transport Vehicle Unloading System, Institute of Organization: STC Engineering Co., Ltd., Research Period: May 1, 2020 to Dec. 31, 2024).

Meanwhile, in all the aspects of the inventive concept, there is no property interest in the government of the Republic of Korea.

### BACKGROUND OF THE DISCLOSURE

### 1. Field of the Disclosure

Embodiments of the present invention relates to an automated cargo unloading technology.

### 2. Description of the Related Art

Over the past three years, a volume of parcel delivery has increased by 10 to 13% annually, but an average delivery cost of parcel has decreased by 2 to 3% annually, and thus automation in a logistics industry is becoming very important to maintain the competitiveness of companies. Currently, automation in logistics centers using equipment such as belt sorters is applied to a significant portion of a parcel delivery process, but an unloading operation of unloading various parcel cargo from a vehicle's cargo box is still dependent on manual work.

In addition, in order to handle a nationwide daily parcel delivery demand, trunk line cargo trucks at hub terminals are usually loaded with about 2,000 cargo per truck, and two workers have to unload all of the cargo within one hour. This is the most intense work among various operations at parcel hub terminals and it is being avoided by workers. Therefore, it is required to develop a robotic system capable of automating the unloading operation of the trunk line cargo trucks.

### SUMMARY OF THE DISCLOSURE

An automated cargo unloading machine according to an embodiment of the present invention is an automated cargo unloading machine for unloading cargo loaded inside a cargo box and including: a main body frame; robotic arm devices provided at both sides of the main body frame, respectively, to unload the loaded cargo; and a conveyor device which is mounted on the main body frame, which is provided between the robotic arm devices, on which the cargo unloaded by the robotic arm devices is seated, and which transports the seated cargo to rearward.

The conveyor device may include a first conveyor unit provided at a front-end portion of the conveyor device and provided to be adjusted in one or more of a height and an inclination in conjunction with an operation of the robotic arm device.

The first conveyor unit may be adjusted in one or more of the height and the inclination according to an unloading mode of the robotic arm device and a loaded position of the cargo to be unloaded by the robotic arm device.

The robotic arm device may determine any one of a down sweep mode, a side sweep mode, a suction mode, and a clamping mode according to one or more of a distance from the cargo, a loaded pattern of the cargo, a loaded position of the cargo, and a type of the cargo.

The first conveyor unit may include: an entrance part provided at a front end of the first conveyor unit in a transverse direction of the first conveyor unit; a transporting part provided at a rear of the entrance part to be narrower than a width of the entrance part and provided in a longitudinal direction of the first conveyor unit; a first side surface part provided at one side of the transporting part at the rear of the entrance part; and a second side surface part provided at the other side of the transporting part at the rear of the entrance part.

The first entrance part may include a first roller provided in parallel with the transverse direction of the first conveyor unit, and the first side surface part and the second side surface part include a conveyor belt that transfers the unloaded cargo to rearward, wherein the first conveyor unit may further include a guide part provided with a certain height at both sides of the first conveyor unit and guiding the cargo transferred to the rearward through the first entrance part, the first side surface part, and the second side surface part.

The guide part may be formed along an external edge of the first side surface part and an external edge of the second side surface part, respectively, and then converged toward a central portion and provided along both edges of the transporting part.

The transporting part may include a first transporting portion including a second roller provided in a longitudinal direction of the transporting part at a central portion of the transporting part and provided in plural in the longitudinal direction of the transporting part in parallel with the transverse direction of the first conveyor unit; a second transporting portion including a third roller provided in the longitudinal direction of the transporting part at a left side of the first transporting portion and provided in plural in the longitudinal direction of the transporting part in a left-diagonal direction; and a third transporting portion including a fourth roller provided in the longitudinal direction of the transporting part at a right side of the first transporting portion and provided in plural in the longitudinal direction of the transporting part in a right-diagonal direction.

The conveyor device may further include: a second conveyor unit provided in a longitudinal direction of the conveyor device at a rear of the first conveyor unit; and a third conveyor unit provided in the longitudinal direction of the conveyor device at a rear of the second conveyor unit.

The second conveyor unit may further include: a fifth roller provided in plural, at a central portion of the second conveyor unit, in a longitudinal direction of the second conveyor unit in parallel with a transverse direction of the second conveyor unit; a sixth roller provided in plural, at a left side of the fifth roller, in the longitudinal direction of the second conveyor unit in a left-diagonal direction; and a seventh roller provided in plural, at a right side of the fifth roller, in the longitudinal direction of the second conveyor unit in a right-diagonal direction, and the third conveyor unit may include an eighth roller provided in plural in a longitudinal direction of the third conveyor unit in parallel with a transverse direction of the third conveyor unit.

The conveyor device may operate the second roller, the fifth roller, and the eighth roller in a first transporting speed, operate the third roller, the fourth roller, the sixth roller, and the seventh roller in a second transporting speed slower than the first transporting speed, and operate the first roller, the first side surface part, and the second side surface part in a third transporting speed slower than the second transporting speed when cargo being unloaded is detected.

The first side surface part and the second side surface part may be provided to be folded vertically downward.

The first side surface part and the second side surface part may be provided to be folded vertically downward when a difference between a width of the loaded cargo and a width of the first conveyor unit is equal to or less than a predetermined value.

### BRIEF DESCRIPTION OF THE DRAWINGS

FIGS. 1 and 2 are a front perspective view and a rear perspective view showing an automated cargo unloading machine according to an embodiment of the present invention.

FIG. 3 is a view showing a state in which an automated cargo unloading machine according to an embodiment of the present invention enters a cargo box and unloads cargo.

FIG. 4 is a perspective view showing a robotic arm device according to an embodiment of the present invention.

FIG. 5 is a view showing each of axis parts in an arm unit of a robotic arm device according to an embodiment of the present invention.

FIGS. 6 and 7 are perspective views showing one side portion and the other side portion of a hand unit according to an embodiment of the present invention.

FIGS. 8A and 8B are views showing a state in which a suction pad portion is moved forward in an embodiment of the present invention.

FIGS. 9A and 9B are views showing a state in which a clamping portion is moved forward in an embodiment of the present invention.

FIGS. 10, 11, 12, 13, 14A, 14B, 14C, 15A, 15B, 15C, 16A, 16B and 16C are views showing an operation of an automated cargo unloading machine unloading cargo from a cargo box according to an embodiment of the present invention.

FIG. 17 is a perspective view showing a conveyor device in an automated cargo unloading machine according to an embodiment of the present invention.

FIG. 18 is a plan view showing a conveyor device in an automated cargo unloading machine according to an embodiment of the present invention.

FIG. 19 is a view showing a transporting direction of cargo in a conveyor device according to an embodiment of the present invention.

FIGS. 20A and 20B are views showing a state in which a first side surface part of a conveyor device is folded downward in an embodiment of the present invention.

### DETAILED DESCRIPTION OF EXEMPLARY EMBODIMENTS

Hereinafter, embodiments of the present invention will be described in more detail with reference to the attached drawings. The embodiments of the present invention may be modified in various forms, and the scope of the present invention should not be construed as being limited to the embodiments below. The embodiments are provided to describe the present invention more completely to those having ordinary skill in the art. Therefore, elements in the drawings are exaggerated to emphasize a clearer description.

In order to make clear the solution of the problem which the present invention seeks to solve, a configuration of the present invention will be described in detail with reference to the attached drawings in accordance with a preferred embodiment of the invention, but in assigning reference numerals to the components of the drawings, it is hereby disclosed in advance that the same components have been assigned the same reference numerals, even though they are on different drawings, and that in the description of the drawings, components of other drawings may be cited where necessary.

Meanwhile, directional terms such as upper side, lower side, one side, other side, etc. are used in relation to the orientation of the disclosed drawings. Since components of embodiments of the present invention may be positioned in a variety of orientations, the directional terms are used for illustrative purposes only and are not limiting.

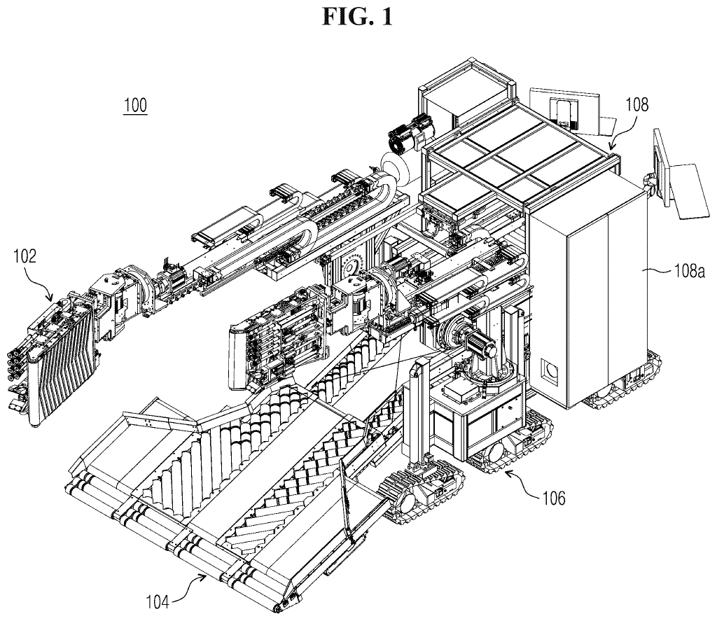

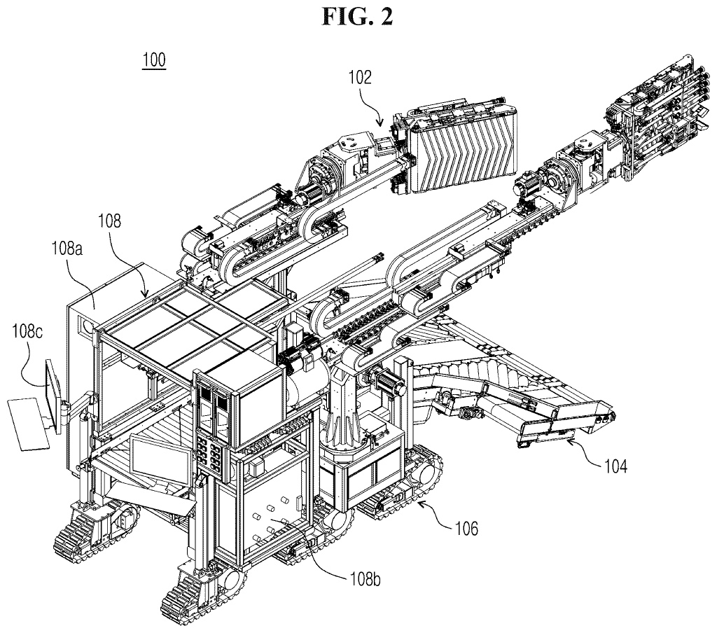

FIGS. 1 and 2 are a front perspective view and a rear perspective view showing an automated cargo unloading machine according to an embodiment of the present invention, and

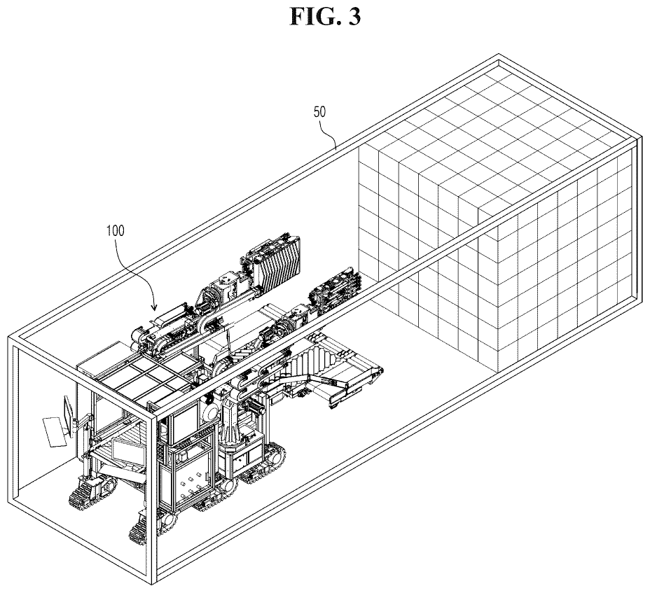

FIG. 3 is a view showing a state in which an automated cargo unloading machine enters a cargo box and unloads cargo according to an embodiment of the present invention.

FIG. 1 is a front perspective view showing an automated cargo unloading machine according to an embodiment of the present invention, and FIG. 2 is a rear perspective view showing an automated cargo unloading machine according to an embodiment of the present invention.

Referring to FIGS. 1 to 3, an automated cargo unloading machine 100 may include a robotic arm device 102, a conveyor device 104, a track device 106, and a main body frame 108.

The automated cargo unloading machine 100 is for unloading or transporting cargo (hereinafter referred to as loaded cargo) loaded inside a cargo box 50. Here, the cargo box 50 may be a cargo box or a container mounted on a cargo vehicle (e.g., a trunk line cargo vehicle, etc.). The automated cargo unloading machine 100 may unload the cargo loaded inside the cargo box at an entrance of the cargo box 50 or as shown in FIG. 3, may enter the inside of the cargo box 50 to unload the cargo loaded inside the cargo box.

In addition, the automated cargo unloading machine 100 may include various sensor equipment (e.g., vision sensor, Lidar, or vision and Lidar fusion sensor, scanner, etc.) for recognizing a loaded pattern of the cargo, a loaded position of the cargo, a type of the cargo, etc. and determining an unloading mode of the cargo according thereto.

The robotic arm device 102 may be provided on both sides of the main body frame 108. That is, the robotic arm device 102 may be provided as a pair on both sides of the main body frame 108. The robotic arm device 102 may be provided to unload various types of the cargo such as boxes, plastic pouches, and sacks that are loaded in bulk inside the cargo box by operating as a pair like human arms. The robotic arm device 102 may unload the cargo loaded inside the cargo box toward the conveyor device 104.

The conveyor device 104 may be mounted on the main body frame 108. The conveyor device 104 may be supported by the main body frame 108. The conveyor device 104 may be provided in a longitudinal direction of the robotic arm device 102 on the main body frame 108. The conveyor device 104 may serve to transport the loaded cargo unloaded by the robotic arm device 102 to a rear of the main body frame 108.

The conveyor device 104 may operate in conjunction with the robotic arm device 102. A front-end portion of the conveyor device 104 may be provided to be adjusted in a height according to the operation of the robotic arm device 102. In this case, the front end portion of the conveyor device 104 may be height-adjusted according to a height of the loaded cargo to be unloaded by the robotic arm device 102.

The track device 106 may be provided under the main body frame 108. The track device 106 may serve to move the automated cargo unloading machine 100. That is, the track device 106 may move the automated cargo unloading machine 100 to the entrance of the cargo box or may allow it to enter the inside of the cargo box.

The main body frame 108 may serve to support the automated cargo unloading machine 100. The main body frame 108 may be provided in various forms capable of supporting the automated cargo unloading machine 100, but the forms are not limited thereto. The main body frame 108 may be provided to support the robotic arm device 102. The main body frame 108 may be provided to support the conveyor device 104. In addition, the main body frame 108 may be connected to the track device 106 at an upper portion of the track device 106.

An electronic control box 108a including circuit devices that provide power to the automated cargo unloading machine 100 and control an operation of the automated cargo unloading machine 100 may be mounted on the main body frame 108. In addition, a hydraulic pressure tank 108b for providing hydraulic pressure to one or more of the robotic arm device 102 and the track device 106 may be mounted on the main body frame 108. In addition, one or more monitors 108c for confirming the operation of the automated cargo unloading machine 100 may be mounted on the main body frame 108.

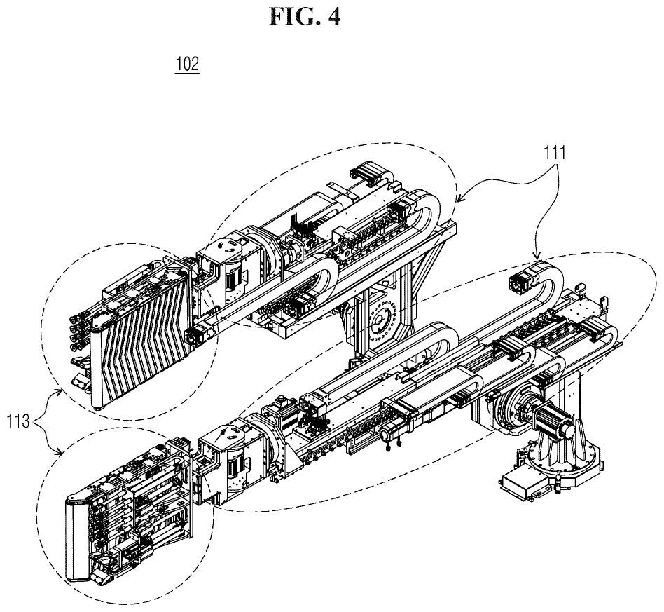

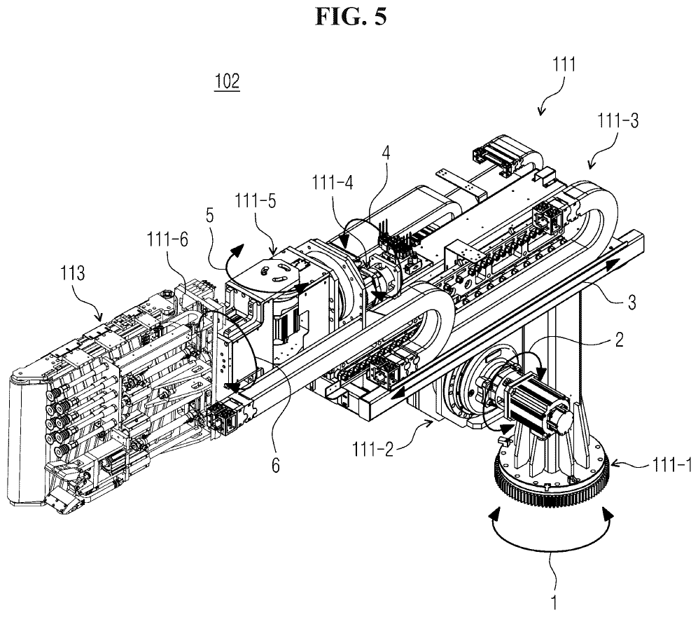

FIG. 4 is a perspective view showing a robotic arm device 102 according to an embodiment of the present invention, and FIG. 5 is a view showing each of axis parts in an arm unit of a robotic arm device 102 according to an embodiment of the present invention.

Referring to FIGS. 4 and 5, the robotic arm device 102 may include an arm unit 111 and a hand unit 113.

The robotic arm device 102 may operate in the unloading mode determined according to one or more of the loaded pattern of the cargo inside the cargo box, the loaded position of the cargo, and the type of the cargo. The unloading mode is an operation mode for unloading the cargo inside the cargo box, for example, the unloading mode may be a down sweep mode, a side sweep mode, a suction mode, and a clamping mode, etc.

The arm unit 111 may be mounted on both sides of the main body frame 108. The arm unit 111 may be provided to enable multiaxial rotation. In addition, the arm unit 111 may be provided to enable forward and backward movement. The arm unit 111 may be provided to perform the multiaxial rotation and the forward or backward movement simultaneously.

In an exemplary embodiment, the arm unit 111 may be provided to have a 6-axis degree of freedom (DoF). The arm unit 111 may include a first axis part 111-1, a second axis part 111-2, a third axis part 111-3, a fourth axis part 111-4, a fifth axis part 111-5, and a sixth axis part 111-6.

The first axis part 111-1 may be mounted on the main body frame 108. The first axis part 111-1 may be provided to enable rotation in a first direction \textcircled{1}. The second axis part 111-2 may be provided in connection with the first axis part 111-1. The second axis part 111-2 may be provided to enable rotation in a second direction \textcircled{2}. The third axis part 111-3 may be provided in connection with the second axis part 111-2. The third axis part 111-3 may be provided to enable forward and backward movement along a third direction \textcircled{3}.

The fourth axis part 111-4 may be provided in connection with the third axis part 111-3. The fourth axis part 111-4 may be provided to enable rotation in a fourth direction \textcircled{4}. The fifth axis part 111-5 may be provided in connection with the fourth axis part 111-4. The fifth axis part 111-5 may be provided to enable rotation in a fifth direction \textcircled{5}. The sixth axis part 111-6 may be provided in connection with the fifth axis part 111-5. The sixth axis part 111-6 may be provided to enable rotation in a sixth direction \textcircled{6}. Here, the first direction \textcircled{1} to the sixth direction \textcircled{6} may be different directions from each other, respectively. In this case, the arm unit 111 may enable forward and backward movement while rotating in five axis directions.

The hand unit 113 may be provided in connection with an end portion of the arm unit 111. The hand unit 113 is a part that contacts the loaded cargo and unloads the loaded cargo toward the conveyor device 104. The hand unit 113 may be provided in connection with the sixth axis part 111-6. Since the hand unit 113 is connected to the arm unit 111, the hand unit 113 may move forward and backward while rotating in the five axis directions together with the arm unit 111 according to an operation of the arm unit 111. As such, the robotic arm device 102 is provided to have the 6-axis Dof, and thus it is possible to unload the loaded cargo by covering an entire range in the cargo box.

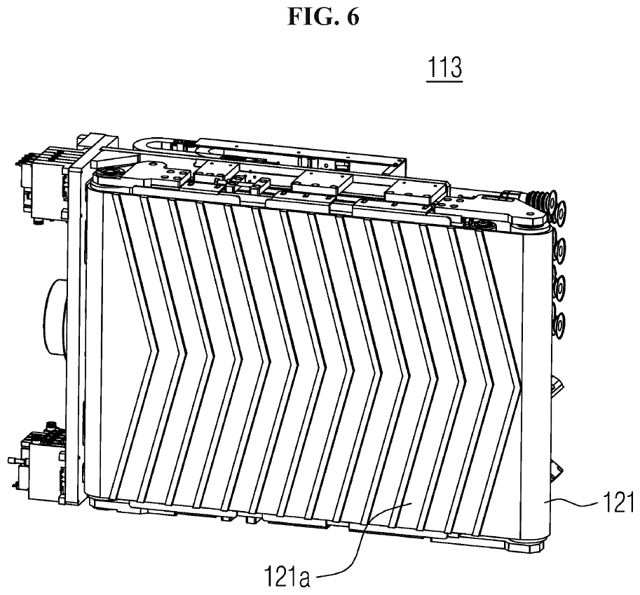

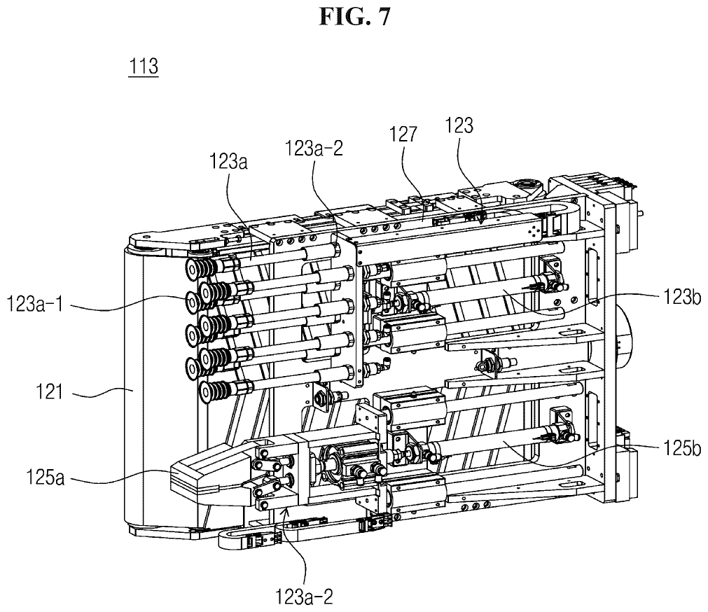

FIGS. 6 and 7 are perspective views showing one side portion and the other side portion of a hand unit 113 according to an embodiment of the present invention.

FIG. 6 is a view showing one side portion of a hand unit 113 according to an embodiment of the present invention, and FIG. 7 is a view showing the other side portion of a hand unit 113 according to an embodiment of the present invention.

Referring to FIGS. 6 and 7, the hand unit 113 may include a conveyor belt 121, a suction part 123, and a clamp part 125.

The unloading conveyor belt 121 may be mounted on the one side portion of the hand unit 113. When the robotic arm device 102 is compared to a human arm, the one side portion of the hand unit 113 may be compared to a palm. The unloading conveyor belt 121 may be provided in a longitudinal direction of the arm unit 111. The unloading conveyor belt 121 may be provided to rotate in a certain direction. For example, the unloading conveyor belt 121 may be provided in a loop shape to rotate circularly.

The unloading conveyor belt 121 may be provided to rotate in a direction of the main body frame 108 (i.e., in an inward direction). That is, in the pair of robotic arm devices 102, the unloading conveyor belt 121 of each of the hand units 113 may be provided to rotate in the direction of the main body frame 108.

As the pair of unloading conveyor belts 121 rotate in the direction of the main body frame 108, the loaded cargo in contact with the pair of unloading conveyor belts 121 between the pair of unloading conveyor belts 121 are swept in the direction of the main body frame 108 and unloaded toward the conveyor device 104. That is, the unloading conveyor belt 121 is used in a sweep mode and may be used when the unloading mode of the robotic arm device 102 is the down sweep mode or the side sweep mode.

An uneven pattern part 121a may be formed on a surface of the unloading conveyor belt 121 to increase friction with the loaded cargo when sweeping down the loaded cargo. The uneven pattern part 121a may be provided in a form that protrudes from the surface of the unloading conveyor belt 121, but it is not limited thereto. The uneven pattern part 121a may be provided in plural at regular intervals along a longitudinal direction of the unloading conveyor belt 121.

The suction part 123 and the clamp part 125 may be provided on the other side portion of the hand unit 113, respectively. When the robotic arm device 102 is compared to a human arm, the other side portion of the hand unit 113 may be compared to a back of a hand. In the other side portion of the hand unit 113, the suction part 123 and the clamp part 125 may be disposed at top and bottom, respectively. The suction part 123 and the clamp part 125 may be provided along a longitudinal direction of the hand unit 113, respectively.

In an exemplary embodiment, the suction part 123 and the clamp part 125 may be mounted on the hand unit 113 through a hand bracket 127. Both sides of the hand bracket 127 may be fixed to both sides of the unloading conveyor belt 121. The hand bracket 127 may be provided between the unloading conveyor belt 121, and the suction part 123 and the clamp part 125.

The suction part 123 may serve to suck and unload the loaded cargo inside the cargo box. That is, the suction part 123 may be used when the unloading mode of the robotic arm device 102 is the suction mode. For example, the suction part 123 may be provided to enable forward and backward movement in the longitudinal direction of the hand unit 113. The suction part 123 may include a suction pad portion 123a and a suction driving portion 123b.

The suction pad portion 123a is a part that sucks the loaded cargo. The suction pad portion 123a may be provided in plural. An end of each of the plurality of suction pad portions 123a may be fixed to a mounting plate 123a-2. The mounting plate 123a-2 may be connected to the suction driving portion 123b. Here, it is shown that the plurality of suction pad portions 123a are provided, but it is not limited thereto.

A suction cup 123a-1 may be provided at an end portion of the suction pad portion 123a to vacuum-suck the loaded cargo. The suction cup 123a-1 may be provided in a bellows shape to be able to bend in various directions, but the shape is not limited thereto.

The suction driving portion 123b may be provided to move the suction pad portion 123a forward and backward. In addition, the suction driving portion 123b may include a vacuum generator so that the suction pad portion 123a sucks the loaded cargo.

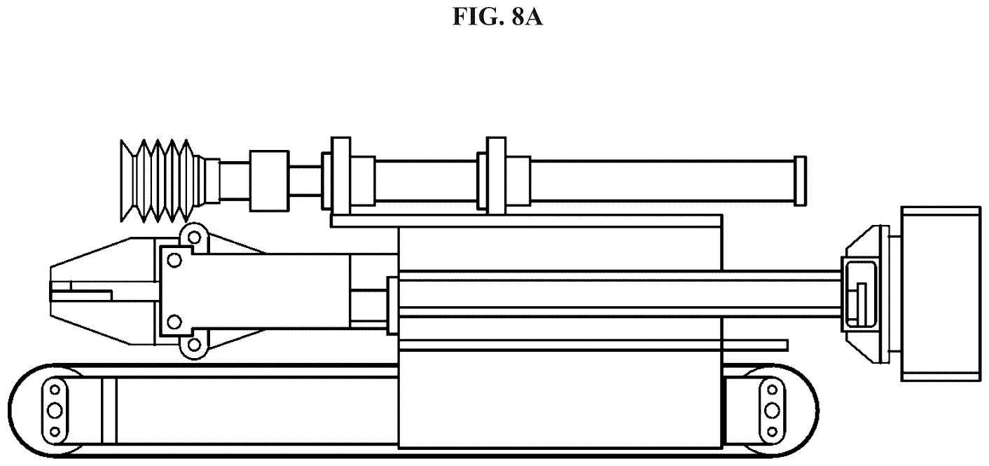

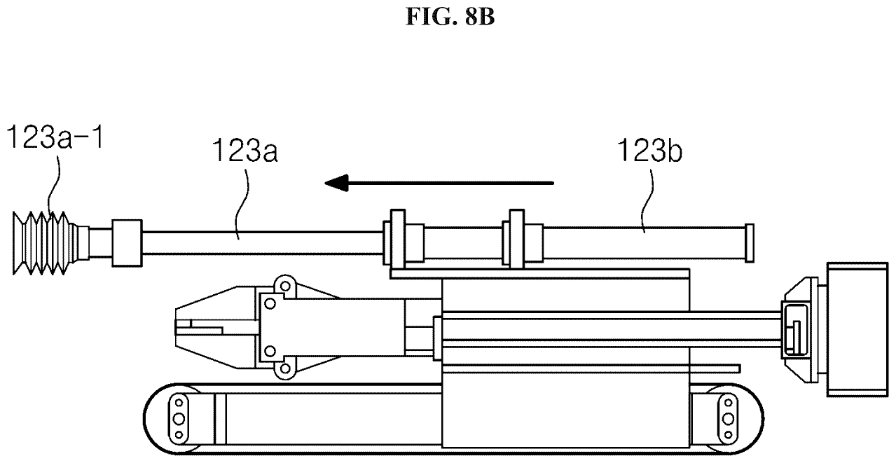

FIG. 8 is a view showing a state in which a suction pad portion 123a is moved forward in an embodiment of the present invention.

FIG. 8A is a view showing a state before the suction pad portion 123a is moved forward in an embodiment of the present invention, and FIG. 8B is a view showing a state after the suction pad portion 123a is moved forward in an embodiment of the present invention.

Referring to FIGS. 8A and 8B, the suction driving portion 123b may move the suction pad portion 123a forward to suck the loaded cargo in the suction mode. The suction driving portion 123b may move the suction pad portion 123a backward to an original position thereof after unloading the sucked loaded cargo.

Here, it is described that the suction pad portion 123a moves forward to suck the loaded cargo, but it is not limited thereto, and the hand unit 111 may also suck the loaded cargo through the suction pad portion 123a after moving toward the loaded cargo in a state in which the suction pad portion 123a is fixed.

The clamp part 125 may serve to pick up to unload the loaded cargo inside the cargo box. That is, the clamp part 125 may be used when the unloading mode of the robotic arm device 102 is the clamping mode. For example, the clamp part 125 may be provided to move forward and backward in the longitudinal direction of the hand unit 113. The clamp part 125 may include a clamping portion 125a and a clamp driving portion 125b.

The clamping portion 125a is a part that picks up the loaded cargo. In this case, the type of the loaded cargo may be a burlap sack. That is, the clamping portion 125a may be provided to pick up the burlap sack from the loaded cargo. To this end, an end portion of the clamping portion 125a may be provided in a clamp shape. The clamp driving portion 125b may be provided to move the clamping portion 125a forward and backward.

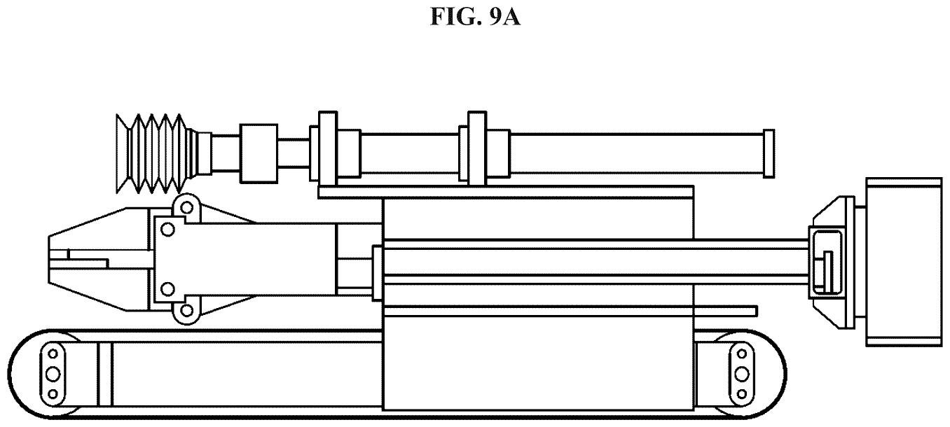

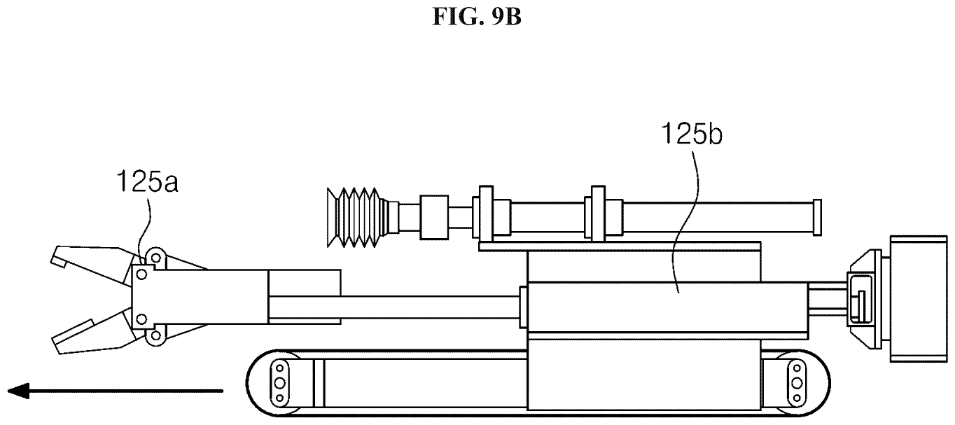

FIG. 9 is a view showing a state in which a clamping portion 125a is moved forward in an embodiment of the present invention.

FIG. 9A is a view showing a state before the clamping portion 125a is moved forward in an embodiment of the present invention, and FIG. 9B is a view showing a state after the clamping portion 125a is moved forward in an embodiment of the present invention.

Referring to FIGS. 9A and 9B, the clamp driving portion 125b may move the clamping portion 125a forward to pick up the loaded cargo in the clamping mode. The clamp driving portion 125b may move the clamping portion 125a backward to an original position thereof after unloading the loaded cargo.

Here, it is described that the clamping portion 125a moves forward to pick up the loaded cargo, but it is not limited thereto, and the hand unit 111 may also be provided to clamp the loaded cargo through the clamping portion 125a after moving toward the loaded cargo in a state in which the clamping portion 125a is fixed.

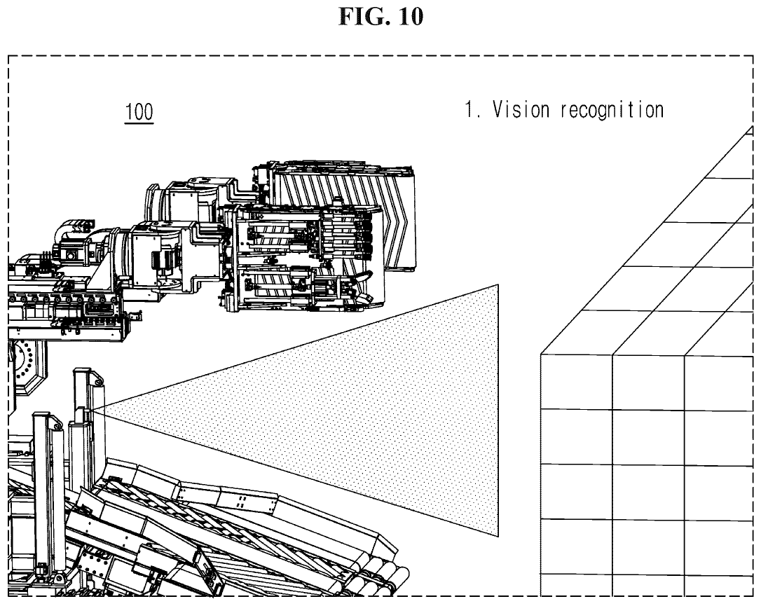

FIGS. 10 to 16 are views showing an operation of an automated cargo unloading machine unloading cargo from a cargo box according to an embodiment of the present invention.

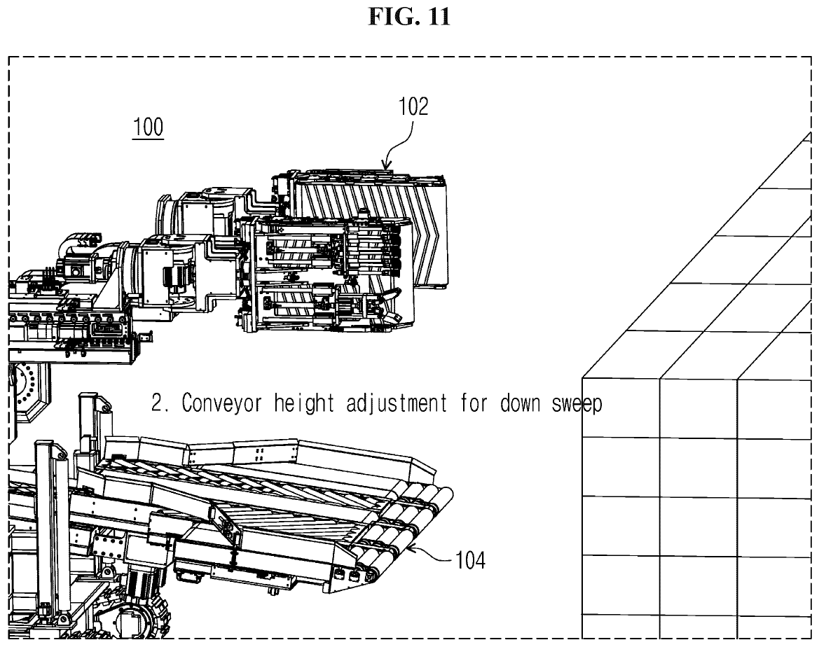

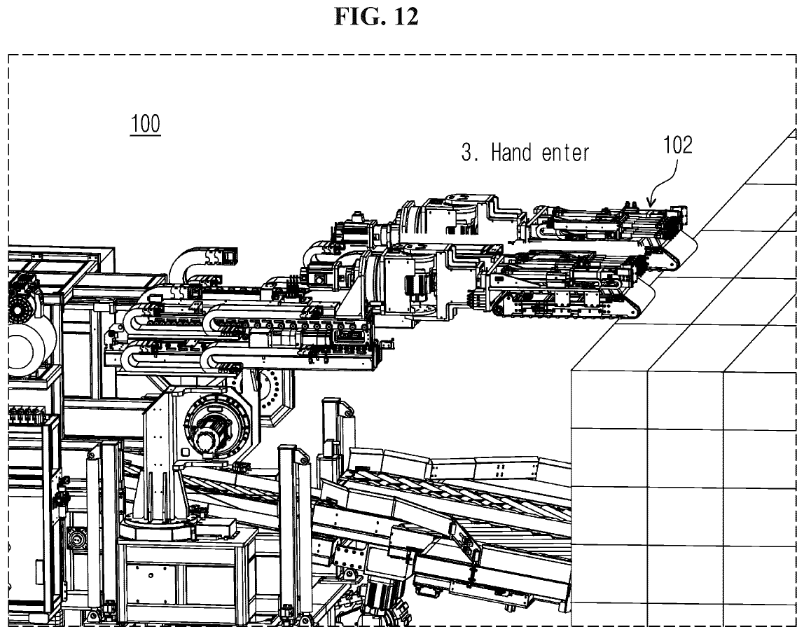

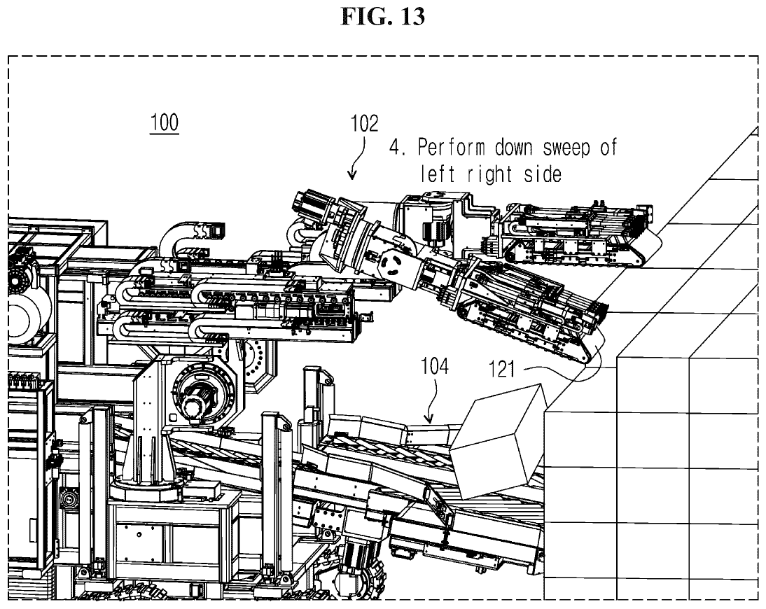

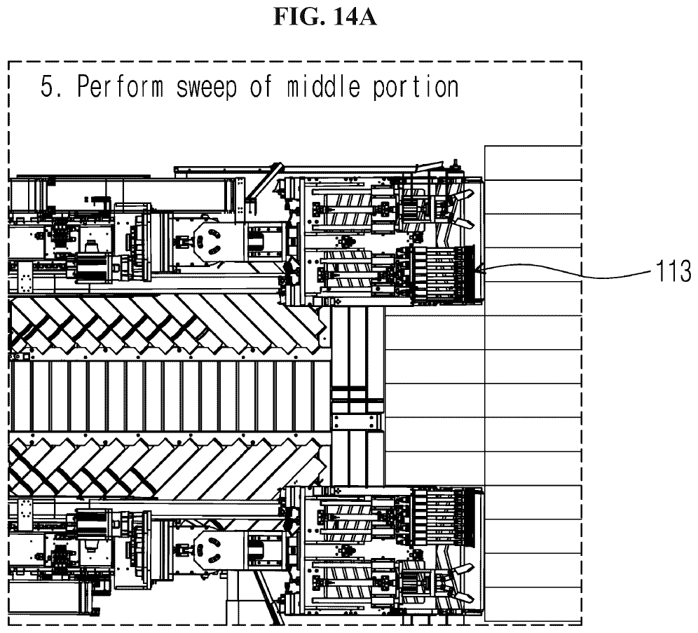

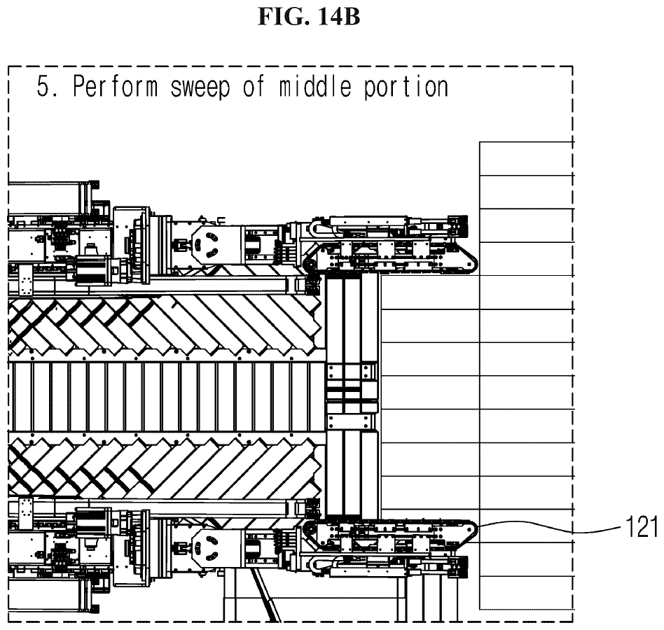

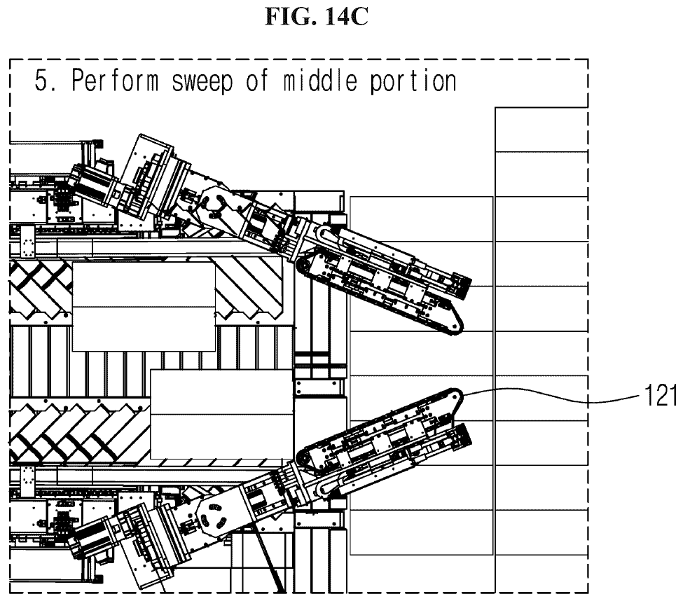

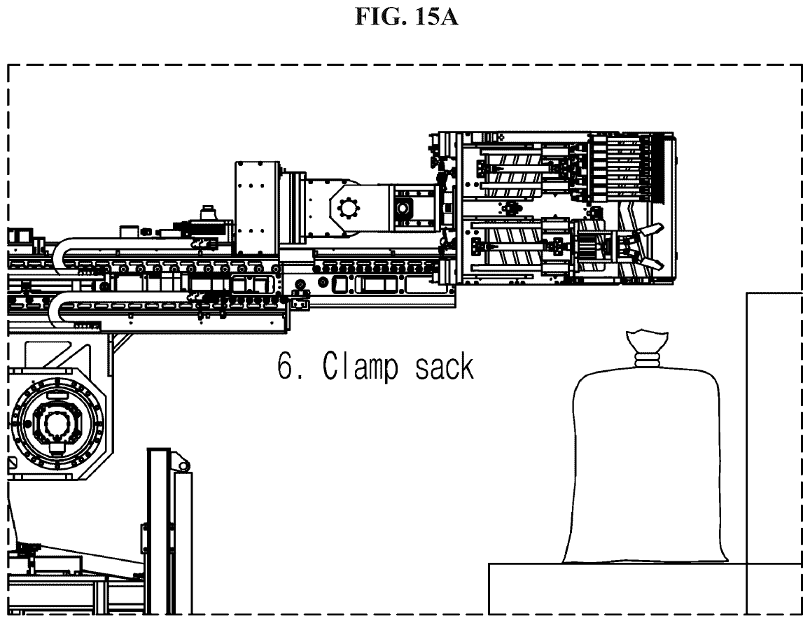

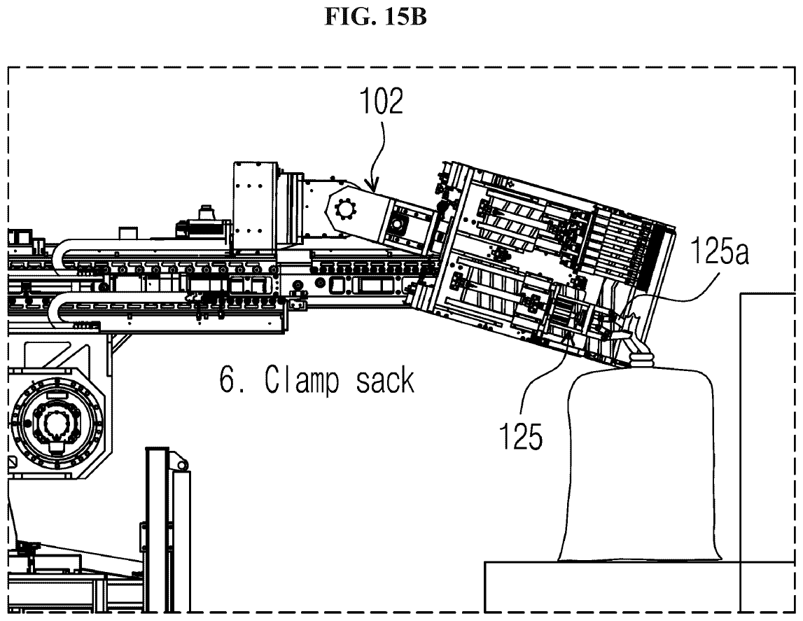

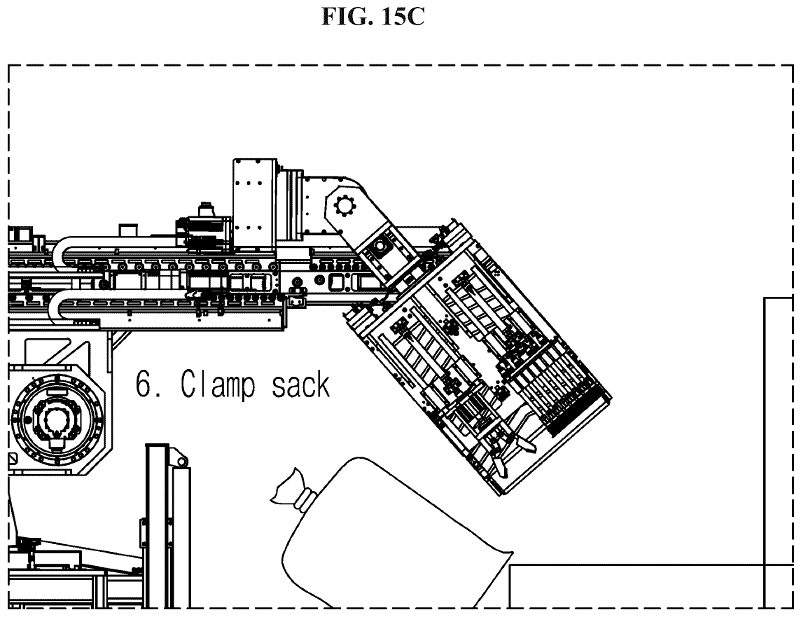

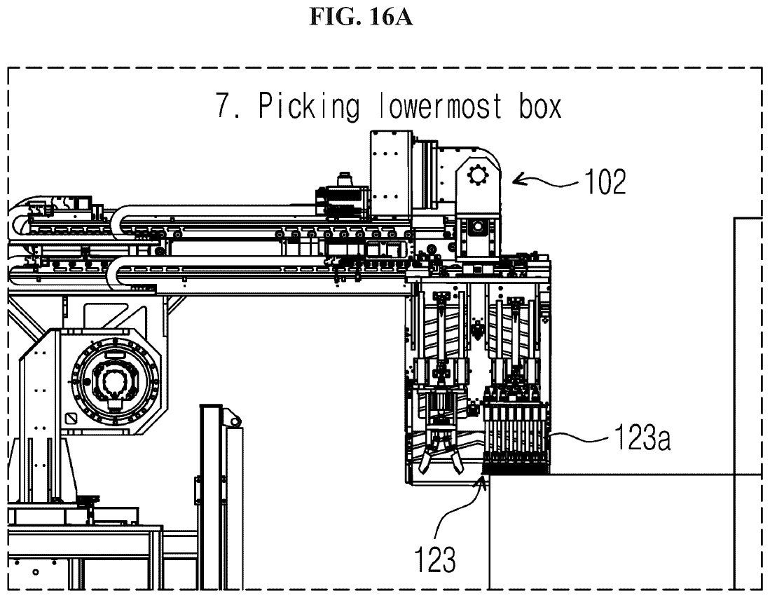

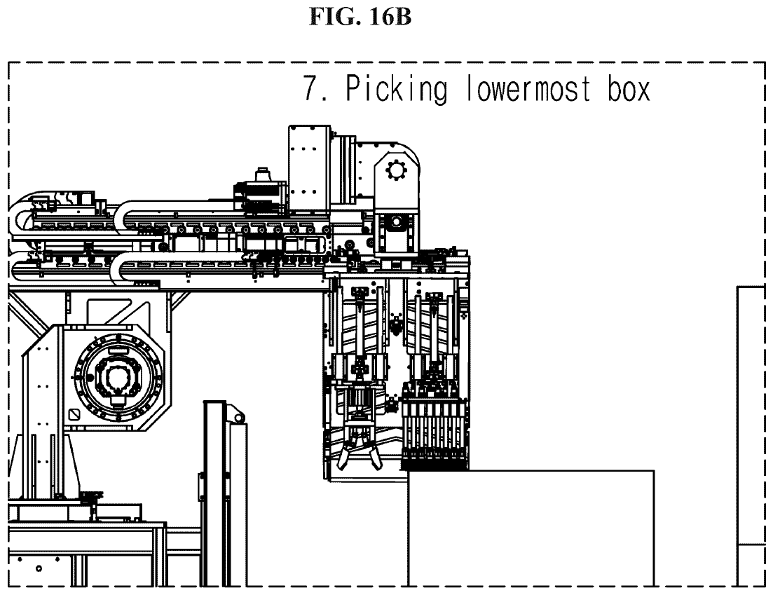

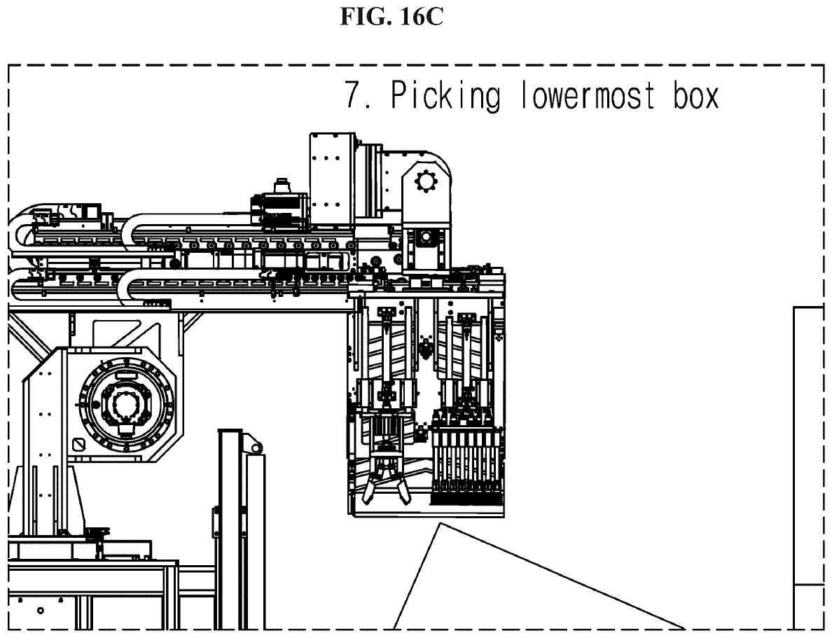

FIG. 10 is a view showing a recognition operation of an automated cargo unloading machine according to an embodiment of the present invention, FIG. 11 is a view showing a height adjustment operation of an automated cargo unloading machine according to an embodiment of the present invention, FIG. 12 is a view showing an upper operation of an automated cargo unloading machine according to an embodiment of the present invention, FIG. 13 is a view showing a down sweep mode operation of an automated cargo unloading machine according to an embodiment of the present invention, FIG. 14 is a view showing a side sweep mode operation of an automated cargo unloading machine according to an embodiment of the present invention, FIG. 15 is a view showing a clamping mode operation of an automated cargo unloading machine according to an embodiment of the present invention, and FIG. 16 is a view showing a suction mode operation of an automated cargo unloading machine according to an embodiment of the present invention.

Referring to FIG. 10, the automated cargo unloading machine 100 may recognize a distance to the cargo, the loaded pattern of the cargo, the loaded position of the cargo, and the type of the cargo, etc. through a vision sensor or the like. In this case, the automated cargo unloading machine 100 may move toward the cargo according to the distance from the cargo. The automated cargo unloading machine 100 may sequentially unload the cargo according to a height of the loaded cargo.

Referring to FIG. 11, the automated cargo unloading machine 100 may adjust a height of a front end portion of the conveyor device 104 according to the height of the loaded cargo. The automated cargo unloading machine 100 may adjust the height of the front end portion of the conveyor device 104 based on the height of the cargo positioned at the uppermost end in the loaded cargo. That is, since the robotic arm device 102 unloads starting with the cargo positioned at the uppermost end in the loaded cargo, the height of the front end portion of the conveyor device 104 may be adjusted to a height at which the cargo positioned at the uppermost end in the loaded cargo may be safely received.

Referring to FIG. 12, the automated cargo unloading machine 100 may position the robotic arm device 102 at an upper portion of the corresponding cargo in order to unload the cargo positioned at the uppermost end in the loaded cargo. In an exemplary embodiment, when the cargo positioned at the uppermost end in the loaded cargo has a box shape and an entry space for the robotic arm device 102 is secured at an upper portion of the cargo positioned at the uppermost end, the robotic arm device 102 may operate in the down sweep mode to unload the cargo positioned at the uppermost end. In this case, the robotic arm device 102 may unload cargo positioned at an outermost in the cargo that is positioned at the uppermost end in the loaded cargo in the down sweep mode, but it is not limited thereto.

Referring to FIG. 13, it shows a state in which the robotic arm device 102 unloads the cargo positioned at the uppermost end in the loaded cargo toward the conveyor device 104 through the down sweep mode. Here, the down sweep mode may refer to an operation mode in which the unloading conveyor belt 121 is rotated in the main body frame 108 direction to sweep the target cargo downward in a state in which the unloading conveyor belt 121 of the hand unit 113 is disposed to face the target cargo at an upper portion of the target cargo (i.e., the cargo to be unloaded) (i.e., a state in which a surface of the unloading conveyor belt 121 faces an upper surface of the target cargo at the upper portion of the target cargo). In this case, depending on a number of the cargo to be unloaded through the down sweep mode or the position of the cargo, etc., the pair of unloading conveyor belts 121 may both operate in the down sweep mode, or only one of them may operate in the down sweep mode.

Referring to FIG. 14, it shows a state in which the robotic arm device 102 unloads the loaded cargo through the side sweep mode. In an exemplary embodiment, after the robotic arm device 102 unloads the cargo positioned at the outermost in the cargo that is positioned at the uppermost end in the loaded cargo in the down sweep mode, the robotic arm device 102 may unload the cargo positioned in a middle part in the side sweep mode. However, it is not limited thereto, and when the cargo positioned at the uppermost end in the loaded cargo has the box shape and the entry space for the robotic arm device 102 is secured at a side portion of the cargo positioned at the uppermost end, the robotic arm device 102 may operate in the side sweep mode to unload the cargo.

Here, the side sweep mode may refer to an operation mode in which the pair of unloading conveyor belts 121 are rotated in the main body frame 108 direction to sweep the target cargo downward in a state in which one or more target cargo is positioned between the pair of unloading conveyor belts 121, and the pair of unloading conveyor belts 121 are disposed to face the target cargo on both side portions of the target cargo (i.e., the cargo to be unloaded) (i.e., a state in which the surface of the unloading conveyor belts 121 faces a side surface of the target cargo at the side portion of the target cargo).

Specifically, the robotic arm device 102 may allow the hand unit 113 to enter a side portion space of the loaded cargo (FIG. 14A). Then, the robotic arm device 102 may be disposed so that the pair of unloading conveyor belts 121 of the hand unit 113 face the side surface of the target cargo (FIG. 14B). Then, the robotic arm device 102 may rotate the pair of unloading conveyor belts 121 in the main body frame 108 direction to unload the target cargo (FIG. 14C). In this case, the automated cargo unloading machine 100 may continue to operate in the side sweep mode while gathering the pair of robotic arm devices 102 mutually inward as the loaded cargo is unloaded.

Referring to FIG. 15, it shows a state in which the robotic arm device 102 unloads the loaded cargo through the clamping mode. In an exemplary embodiment, the automated cargo unloading machine 100 may operate the robotic arm device 102 in the clamping mode according to the type of the cargo to be unloaded. For example, when the type of the cargo to be unloaded is a cargo that may be picked up through the clamp part 125, such as the burlap sack or pouch, the automated cargo unloading machine 100 may operate the robotic arm device 102 in the clamping mode.

Specifically, when the type of the cargo is the burlap sack (FIG. 15A), the robotic arm device 102 may move the hand unit 113 toward the target cargo, and then pick up the target cargo through the clamping portion 125a of the clamp part 125 (FIG. 15B). In this case, the clamping portion 125a may be moved forward according to a distance from the target cargo. Then, the robotic arm device 102 may pull down the target cargo to unload the target cargo (FIG. 15C).

Referring to FIG. 16, it shows a state in which the robotic arm device 102 unloads the loaded cargo through the suction mode. In an exemplary embodiment, the robotic arm device 102 may unload the cargo in the suction mode according to one or more of the height of the loaded cargo and the type of the cargo. For example, when the target cargo is positioned at the lowermost end or the uppermost end and the cargo has the box shape, the robotic arm device 102 may unload the target cargo through the suction mode. FIG. 16 shows a state in which the cargo is unloaded in the suction mode when the target cargo has the box shape and is positioned at the lowermost end.

Specifically, the robotic arm device 102 may suck the target cargo through the suction pad portion 123a of the suction part 123 (FIG. 16A). In this case, the suction pad portion 123a may be moved forward according to the distance from the target cargo. Then, the robotic arm device 102 may move the target cargo to an upper portion of the conveyor device 104 in a state in which the target cargo is sucked (FIG. 16B). Then, the robotic arm device 102 may detach the target cargo from the suction pad portion 123a to unload the target cargo onto the conveyor device 104 (FIG. 16C).

According to the disclosed embodiment, the automated cargo unloading machine 100 is equipped with the pair of robotic arm devices 102 capable of multiaxial rotation and movement, and the robotic arm device 102 is equipped with the unloading conveyor belt 121, the suction part 123, and the clamp part 125, and accordingly, the automated cargo unloading machine 100 may unload the loaded cargo easily and quickly by operating in various unloading modes such as the down sweep mode, the side sweep mode, the suction mode, and the clamping mode according to the position of the loaded cargo, the loaded pattern of the cargo, and the type of the cargo, etc.

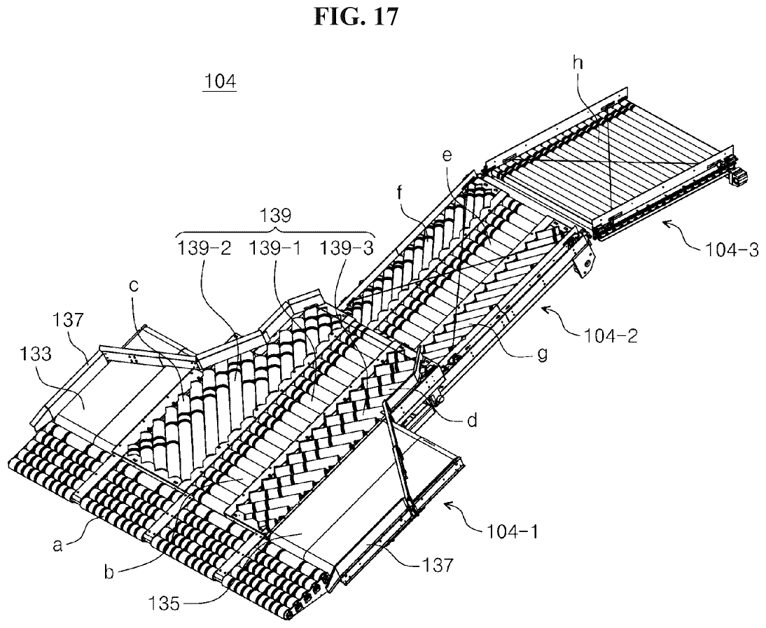

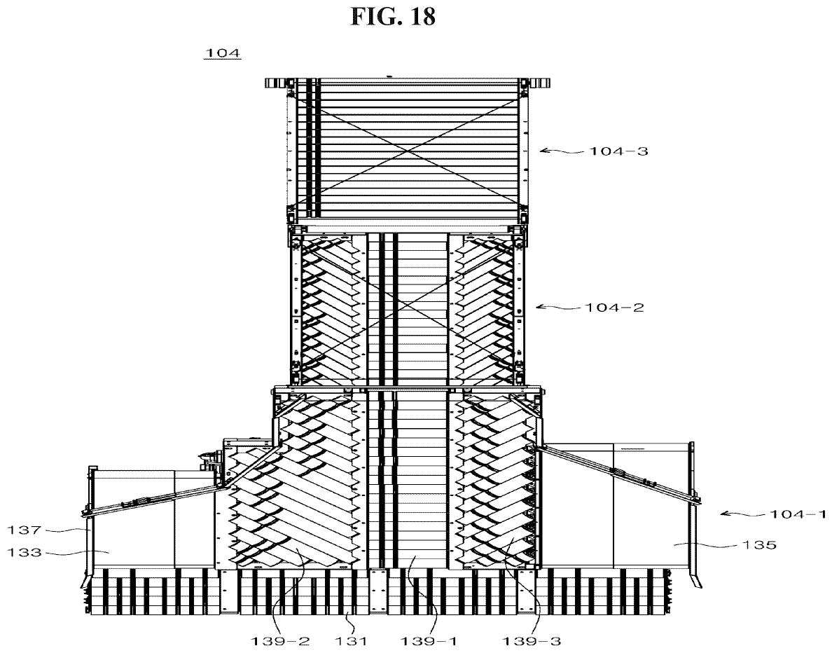

FIG. 17 is a perspective view showing a conveyor device in an automated cargo unloading machine according to an embodiment of the present invention, and FIG. 18 is a plan view showing a conveyor device in an automated cargo unloading machine according to an embodiment of the present invention.

Referring to FIGS. 17 and 18, a conveyor device 104 may be provided between a pair of robotic arm devices 102. The conveyor device 104 may serve to singulate cargo unloaded by the pair of robotic arm devices 102. That is, the conveyor device 104 may serve to auto-align and transport the cargo unloaded by the pair of robotic arm devices 102. The conveyor device 104 may include a first conveyor unit 104-1, a second conveyor unit 104-2, and a third conveyor unit 104-3.

The first conveyor unit 104-1 may be provided at a front-end portion of the conveyor device 104. The first conveyor unit 104-1 may serve to receive the cargo unloaded by the pair of robotic arm devices 102. The first conveyor unit 104-1 may be provided to be adjusted in a height from a ground. In addition, the first conveyor unit 104-1 may be provided to be adjusted in an inclination.

In an exemplary embodiment, the first conveyor unit 104-1 may be provided to be adjusted in one or more of the height and the inclination according an unloading mode of the pair of robotic arm devices 102 and a position of cargo to be unloaded by the pair of robotic arm devices 102 in the cargo box. In this case, the first conveyor unit 104-1 may be adjusted to have the height and the inclination capable of safely receiving the unloaded cargo.

The first conveyor unit 104-1 may include an entrance part 131, a first side surface part 133, a second side surface part 135, a guide part 137, and a transporting part 139.

The entrance part 131 may be provided at a front end of the first conveyor unit 104-1. The entrance part 131 may be provided to have a preset first width. The entrance part 131 may include a plurality of first rollers a to transfer the cargo unloaded by the pair of robotic arm devices 102 to the transporting part 139 at the rear. In this case, the first rollers may be provided in parallel with a transverse direction of the first conveyor unit 104-1. In addition, the first rollers may be disposed in a longitudinal direction of the entrance part 131.

The first side surface part 133 may be provided at one side portion of the transporting part 137 at the rear of the entrance part 131. The first side surface part 133 may include a conveyor belt to transfer the cargo unloaded by the pair of robotic arm devices 102 to rearward.

The second side surface part 135 may be provided on the other side portion of the transporting part 137 at the rear of the entrance part 131. The second side surface part 135 may include the conveyor belt to transfer the cargo unloaded by the pair of robotic arm devices 102 to rearward.

The guide part 137 may be provided with a certain height at both side portions of the first conveyor unit 104-1. The guide part 137 may be seated on the entrance part 131, the first side surface part 133, and the second side surface part 135 to serve to guide the cargo transferred to the rearward to the transporting part 139.

The guide part 137 may be formed along an external edge of the first side surface part 133 and an external edge of the second side surface part 133, respectively, and then converged toward a central portion and provided along both edges of the transporting part 137. The guide part 137 may also serve to prevent the cargo unloaded by the pair of robotic arm devices 102 from being separated to the outside of the first conveyor unit 104-1.

The transporting part 139 may be provided between the first side surface part 133 and the second side surface part 135 at the rear of the entrance part 131. The transporting part 139 may be provided to have a second width smaller than a width of the entrance part 131. The transporting part 139 may serve to transport the cargo transferred through the entrance part 131, the first side surface part 133, and the second side surface part 135 to the second conveyor unit 104-2 at the rear.

The transporting part 139 may include a first transporting portion 139-1, a second transporting portion 139-2, and a third transporting portion 139-3. The first transporting portion 139-1 may be provided in a longitudinal direction of the transporting part 139 at a central portion of the transporting part 139. The first transporting portion 139-1 may include second rollers b provided in parallel with the transverse direction of the first conveyor unit 104-1 and provided in plural in the longitudinal direction of the transporting part 139.

The second transporting portion 139-2 may be provided in the longitudinal direction of the transporting part 139 at a left side of the first transporting portion 139-1. The second transporting portion 139-2 may include third rollers c provided in a left-diagonal direction and provided in plural in the longitudinal direction of the transporting part 139.

The third transporting portion 139-3 may be provided in the longitudinal direction of the transporting part 139 at a right side of the first transporting portion 139-1. The third transporting portion 139-2 may include fourth rollers d provided in a right-diagonal direction and provided in plural in the longitudinal direction of the transporting part 139.

Here, the second transporting portion 139-2 includes the third rollers c in the left-diagonal direction and the third transporting portion 139-2 includes the fourth rollers d in the right-diagonal direction, and accordingly, cargo on the first conveyor unit 104-1 may be converged toward a center of the transporting part 139 (i.e., the first transporting portion 139-1) and transported to rearward.

The second conveyor unit 104-2 may be provided in a longitudinal direction of the conveyor device 104 at a rear of the first conveyor unit 104-1. The second conveyor unit 104-2 may be provided to be inclined downward at a certain angle, but it is not limited thereto. The first conveyor unit 104-1 may be provided to be tiltably coupled at an end portion of the second conveyor unit 104-2.

Fifth rollers e may be provided in a longitudinal direction of the second conveyor unit 104-2 in parallel with a transverse direction of the second conveyor unit 104-2 at a central portion of the second conveyor unit 104-2. A sixth roller f and a seventh roller g may be provided at both side portions of the second conveyor unit 104-2. The sixth roller f may be provided at a left side of the fifth roller e in the longitudinal direction of the second conveyor unit 104-2 in a left-diagonal direction. The seventh roller g may be provided at a right side of the fifth roller e in the longitudinal direction of the second conveyor unit 104-2 in a right-diagonal direction.

The third conveyor unit 104-3 may be provided in the longitudinal direction of the conveyor device 104 at a rear of the second conveyor unit 104-2. A width of the third conveyor unit 104-3 may be provided to correspond to a width of the second conveyor unit 104-2. The third conveyor unit 104-3 may include a plurality of eighth rollers h provided in a longitudinal direction of the third conveyor unit 104-3 in parallel with a transverse direction of the third conveyor unit 104-3.

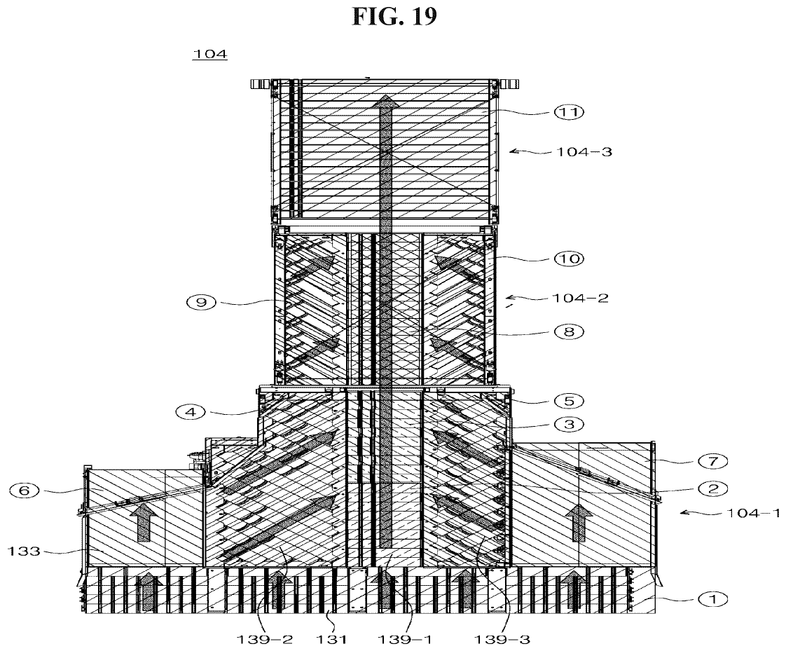

FIG. 19 is a view showing a transporting direction of cargo in a conveyor device according to an embodiment of the present invention. Referring to FIG. 19, the conveyor device 104 may be divided into a first section to an eleventh section. A first section \textcircled{1} may be an area where the entrance part 131 is provided. A second section 2 may be an area where a front-end portion of the first transporting portion 139-1 is positioned. A third section \textcircled{3} may be an area where a rear-end portion of the first transporting portion 139-1 is positioned. A fourth section \textcircled{4} may be an area where the second transporting portion 139-2 is provided. A fifth section \textcircled{5} may be an area where the third transporting portion 139-3 is provided. A sixth section \textcircled{6} may be an area where the first side surface part 133 is provided. A seventh section \textcircled{7} may be an area where the second side surface part 135 is provided. An eighth section \textcircled{8} may be an area where the fifth rollers e of the second conveyor unit 104-2 are provided. A ninth section \textcircled{9} may be an area where the sixth rollers f of the second conveyor unit 104-2 are provided. A tenth section \textcircled{10} may be an area where the seventh rollers g of the second conveyor unit 104-2 are provided. An eleventh section \textcircled{11} may be an area where the third conveyor unit 104-3, that is, the eighth roller h, is provided.

Here, the conveyor device 104 may be equipped with one or more sensors capable of detecting the cargo unloaded by the pair of robotic arm devices 102. When the cargo seated on the conveyor device 104 is detected, the conveyor device 104 may operate the entire section. In this case, the cargo is auto-aligned to the central portion of the conveyor device 104 and transported to rearward as shown in an arrow direction in FIG. 19.

Meanwhile, the conveyor device 104 may control a transporting speed of the cargo (or a rotation speed of the conveyor belt or the roller) for each section to singulate the cargo unloaded by the pair of robotic arm devices 102.

In an exemplary embodiment, the second section \textcircled{2}, the third section \textcircled{3}, the eighth section \textcircled{8}, and the eleventh section \textcircled{11} may operate in a first transporting speed. In addition, the fourth section \textcircled{4}, the fifth section \textcircled{5}, the ninth section \textcircled{9}, and the tenth section \textcircled{10} may operate in a second transporting speed slower than the first transporting speed. In addition, the first section \textcircled{1}, sixth section \textcircled{6}, and seventh section \textcircled{7} may be operated in a third transporting speed slower than the second transporting speed.

Meanwhile, the first side surface part 133 and the second side surface part 135 may be provided to be folded vertically downward. The first side surface part 133 and the second side surface part 135 may be provided to be rotatable at both sides of the transporting part 139, respectively.

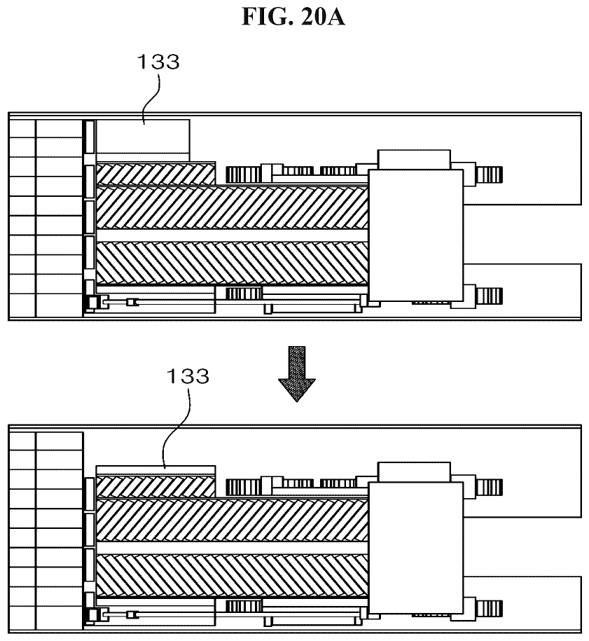

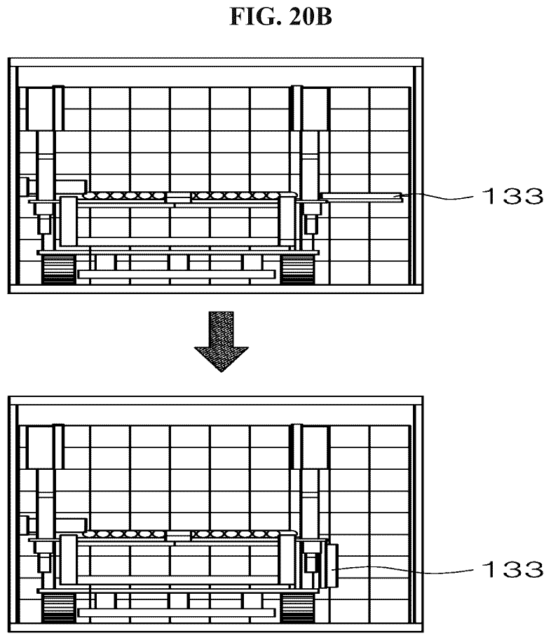

FIG. 20 is a view showing a state in which a first side surface part 133 of a conveyor device 104 is folded downward in an embodiment of the present invention. FIG. 20A is a view showing an automated cargo unloading machine viewed from above, and FIG. 20B is a view showing the automated cargo unloading machine viewed from the rear. Here, a state in which the first side surface part 133 is folded downward is shown, but the second side surface part 133 may also be configured in the same way.

Referring to FIG. 20, the first side surface part 133 may be provided to be folded vertically downward according to a difference between a width of the loaded cargo and a width of the first conveyor unit 104-1. For example, when the difference between the width of the loaded cargo and the width of the first conveyor unit 104-1 is less than or equal to a predetermined reference value, the automated cargo unloading machine 100 may fold the first side surface part 133 downward to secure a space that was occupied by the first side surface part 133. In this case, workers may move through the space that was occupied by the first side surface part 133. That is, the space that was occupied by the first side surface part 133 may be secured as an entry passage for workers.

The above detailed description is illustrative of the present invention. In addition, the above-mentioned description describes preferred embodiments of the present invention, and the present invention may be used in various other combinations, modifications, and environments. That is, modifications or amendments are possible within the scope of the spirit of the invention disclosed herein, the scope equivalent to the described disclosure, and/or the scope of technology or knowledge in the related art. The described embodiments are intended to describe the best possible state for implementing the technical idea of the present invention, and various modifications required for specific application fields and uses of the present invention are also possible. Therefore, the detailed description of the invention is not intended to limit the present invention to the disclosed embodiments. In addition, the appended claims should be construed to include other embodiments.

What is claimed is:

1. An automated cargo unloading machine for unloading cargo loaded inside a cargo box comprising:
a main body frame;
robotic arm devices provided at both sides of the main body frame, respectively, to unload the loaded cargo; and
a conveyor device which is mounted on the main body frame, which is provided between the robotic arm devices, on which the cargo unloaded by the robotic arm devices is seated, and which transports the seated cargo to rearward.

2. The automated cargo unloading machine of claim 1,
wherein the conveyor device comprises a first conveyor unit provided at a front-end portion of the conveyor device and provided to be adjusted in one or more of a height and an inclination in conjunction with an operation of the robotic arm device.

3. The automated cargo unloading machine of claim 2,
wherein the first conveyor unit is adjusted in one or more of the height and the inclination according to an unloading mode of the robotic arm device and a loaded position of the cargo to be unloaded by the robotic arm device.

4. The automated cargo unloading machine of claim 3,
wherein the robotic arm device determines any one of a down sweep mode, a side sweep mode, a suction mode, and a clamping mode according to one or more of a distance from the cargo, a loaded pattern of the cargo, a loaded position of the cargo, and a type of the cargo.

5. The automated cargo unloading machine of claim 2,
wherein the first conveyor unit comprises:
an entrance part provided at a front end of the first conveyor unit in a transverse direction of the first conveyor unit;
a transporting part provided at a rear of the entrance part to be narrower than a width of the entrance part and provided in a longitudinal direction of the first conveyor unit;
a first side surface part provided at one side of the transporting part at the rear of the entrance part; and
a second side surface part provided at the other side of the transporting part at the rear of the entrance part.

6. The automated cargo unloading machine of claim 5,
wherein the first entrance part comprises a first roller provided in parallel with the transverse direction of the first conveyor unit, and
the first side surface part and the second side surface part include a conveyor belt that transfers the unloaded cargo to rearward,
wherein the first conveyor unit further comprises a guide part provided with a certain height at both sides of the first conveyor unit and guiding the cargo transferred to the rearward through the first entrance part, the first side surface part, and the second side surface part.

7. The automated cargo unloading machine of claim 6,
wherein the guide part is formed along an external edge of the first side surface part and an external edge of the second side surface part, respectively, and then converged toward a central portion and provided along both edges of the transporting part.

8. The automated cargo unloading machine of claim 6,
wherein the transporting part comprises:
a first transporting portion including a second roller provided in a longitudinal direction of the transporting part at a central portion of the transporting part and provided in plural in the longitudinal direction of the transporting part in parallel with the transverse direction of the first conveyor unit;
a second transporting portion including a third roller provided in the longitudinal direction of the transporting part at a left side of the first transporting portion and provided in plural in the longitudinal direction of the transporting part in a left-diagonal direction; and
a third transporting portion including a fourth roller provided in the longitudinal direction of the transporting part at a right side of the first transporting portion and provided in plural in the longitudinal direction of the transporting part in a right-diagonal direction.

9. The automated cargo unloading machine of claim 8,
wherein the conveyor device further comprises:
a second conveyor unit provided in a longitudinal direction of the conveyor device at a rear of the first conveyor unit; and
a third conveyor unit provided in the longitudinal direction of the conveyor device at a rear of the second conveyor unit.

10. The automated cargo unloading machine of claim 9,
wherein the second conveyor unit further comprises:
a fifth roller provided in plural, at a central portion of the second conveyor unit, in a longitudinal direction of the second conveyor unit in parallel with a transverse direction of the second conveyor unit;
a sixth roller provided in plural, at a left side of the fifth roller, in the longitudinal direction of the second conveyor unit in a left-diagonal direction; and
a seventh roller provided in plural, at a right side of the fifth roller, in the longitudinal direction of the second conveyor unit in a right-diagonal direction, and
wherein the third conveyor unit comprises
an eighth roller provided in plural in a longitudinal direction of the third conveyor unit in parallel with a transverse direction of the third conveyor unit.

11. The automated cargo unloading machine of claim 10,
wherein the conveyor device operates the second roller, the fifth roller, and the eighth roller in a first transporting speed, operates the third roller, the fourth roller, the sixth roller, and the seventh roller in a second transporting speed slower than the first transporting speed, and operates the first roller, the first side surface part, and the second side surface part in a third transporting speed slower than the second transporting speed when cargo being unloaded is detected.

12. The automated cargo unloading machine of claim 5,
wherein the first side surface part and the second side surface part are provided to be folded vertically downward.

13. The automated cargo unloading machine of claim 12,
wherein the first side surface part and the second side surface part are provided to be folded vertically downward when a difference between a width of the loaded cargo and a width of the first conveyor unit is equal to or less than a predetermined value.
